(19) United States
(12) Patent Application Publication
(10) Pub. No.: US 2026/0035924 A1
(43) Pub. Date: Feb. 5, 2026

(54) ROOFING COMPOSITIONS COMPRISING LINEAR LOW-DENSITY POLYETHYLENE

(71) Applicant: JOHNS MANVILLE, Denver, CO (US)

(72) Inventors: Diego Pedrazzoli, Boulder, CO (US); ChangQing Shen, Centennial, CO (US); Lance Wang, Parker, CO (US); Jawed Asrar, Englewood, CO (US)

(21) Appl. No.: 18/791,732

(22) Filed: Aug. 1, 2024

(51) Int. Cl. E04D 5/06; B29C 48/00; B29C 48/28; B29C 48/40; B29K 23/00; B29K 105/00; B29K 505/00; B29L 31/10; C08K 3/26; C08L 23/06

(52) U.S. Cl. CPC E04D 5/06; B29C 48/0019; B29C 48/022; B29C 48/28; B29C 48/40; C08K 3/26; C08L 23/06; B29K 2023/0625; B29K 2023/12; B29K 2105/0026; B29K 2105/0032; B29K 2105/0044; B29K 2505/00; B29L 2031/108; C08K 2003/265; C08L 2201/02; C08L 2205/02; C08L 2207/066

(57) ABSTRACT

Provided is a roofing membrane composition comprising from 3 to 6 wt % of a thermoplastic polypropylene polymer, from 32 to 57 wt % of a linear low density polyethylene, and from 5 to 25 wt % of a performance modifier polymer. The roofing membrane composition has been found to provide an economical roofing membrane which meets the elevated temperature requirements now demanded in the industry. The roofing membrane composition further comprises a flame retardant, an ultraviolet stabilizer, and a pigment.

### FIELD OF THE INVENTION

Formulations are provided which are useful in roofing applications. Linear low density polyethylene is blended with thermoplastic olefin (TPO) polymers, and a performance modifier, which blend can be used to prepare a roofing membrane of enhanced properties.

### BACKGROUND

Compositions and membranes comprising thermoplastic olefin (TPO) polymers have found widespread use in the roofing industry for commercial buildings. For roofing and other sheeting applications, the products are typically manufactured as membrane sheets. The sheets are typically sold, transported, and stored in rolls. For roofing membrane applications, several sheets are unrolled at the installation site, placed adjacent to each other with an overlapping edge to cover the roof and are sealed together by a heat welding process during installation. During transport and storage, the rolls can be exposed to extreme heat conditions, such as from 40° C. to 100° C., which can lead to roll blocking of the rolls during storage in a warehouse. After installation, the membranes can be exposed during service to a wide range of conditions that may deteriorate or destroy the integrity of the membrane. As such, a membrane is desired that can withstand a wide variety of service temperatures, with a particular focus on thermal and UV stability.

Thermoplastic olefin roofing membranes require high flexibility together with good mechanical stability at elevated temperatures, and high weathering resistance. A number of proposals for thermoplastic olefin films of this type are disclosed in the following publications.

US 2006/0046084 describes a thermoplastic polyolefin roofing membrane produced from a mixture of a polypropylene-based elastomer (PBE) and polyolefin copolymers.

US 2010/0255739 describes a roofing membrane with a composition comprising a propylene-based elastomer.

US 2010/0197844 describes a thermoplastic olefin membrane for use in construction materials which comprises a polypropylene-based elastomer.

PCT Publication WO 2010/0115079A1 is directed to roofing membranes that contain compositions comprising a propylene based elastomer and an impact propylene-ethylene copolymer. The propylene based elastomer is Vistamaxx™ 6102.

PCT Publication WO 2014/001224A1 is directed to compositions comprising 40 to 75 wt % of at least one polypropylene-based elastomer and around 25 to 60 wt % of at least one random copolymer of polypropylene. The polypropylene-based elastomers used in WO 2014/001224A1 were Vistamaxx™ 3980, 6102, and 6202.

PCT Publication WO 2014/040914A1 is directed to thermoplastic mixtures that comprise at least one impact-resistant polypropylene copolymer and at least one ethylene-1-octene copolymer, where the weight ratio of impact-resistant polypropylene copolymer to ethylene-1-octene copolymer is in the range of 35:65 to 65:35.

U.S. Pat. No. 9,434,827 discloses a composition which is useful in roofing membranes that comprises on a polymer basis, from 40 to 75% by weight of at least one propylene based elastomer; and 25 to 60% by weight of at least one random polypropylene copolymer.

U.S. Pat. No. 10,414,140 is directed to a roofing membrane composition of a 10-50 wt % of a propylene-based elastomer, 5-40 wt % of a thermoplastic resin, at least one flame retardant, and at least one ultraviolet stabilizer.

US 2021/0024733 describes a polymer blend that includes 35 to 50 wt % of at least one propylene-based elastomer, 25 to 50 wt % of at least one impact polymer and 15 to 25 wt % of at least one low density polyethylene component. The polymer blend is useful for making a roofing membrane.

U.S. Pat. Nos. 10,619,037 and 10,647,839 both describe membrane compositions based on particular polymer blends. The polymer blends comprise from 30-60 wt % of a linear low density polyethylene and from 20-65 wt % of a propylene polymer having from 10-60% crystallinity with rubber dispersed therein. From 5-20 wt % of the polymer blend is a combination of two performance modifiers. One is a polypropylene matrix copolymer and the other is a polyethylene matrix copolymer. See also, U.S. Pat. Nos. 11,286,380; 11,578,197; and U.S. Pat. Pub. No. 2023/0083883.

In traditional mixtures, an at least semicrystalline polyolefin material such as polyethylene or polypropylene, which provides the mechanical strength and resistance to temperature change, is mixed with a flexible blend component. This flexible blend component is miscible, or at least compatible, with the polyolefin. Flexible blend components used to date include, ethylene-propylene-rubber (EPM), ethylene-n-alkene copolymers, and also polypropylene-based elastomers. At present, the most common TPO polymer used in roofing membranes is Hifax™ CA10A, which is a polypropylene random copolymer matrix with EP rubber well dispersed throughout the polypropylene phase. This TPO formulation relies on in-reactor blend resin that has only a minor polypropylene copolymer as the matrix phase and the EP rubber as the majority phase, which is well dispersed in the polypropylene. The rubber phase is so fine and uniformly distributed that it cannot be made by any conventional mechanical mixing. However, improvements, cost efficiency and reproducibility are still needed.

There still remains a need for roofing membranes that demonstrate flexibility at service temperatures, particularly elevated temperatures. There is also a need for more economical roofing membranes which can meet such elevated temperature requirements.

### SUMMARY

Provided is a roofing membrane composition comprising from 3 to 6 wt % of a thermoplastic polypropylene polymer, from 32 to 55 wt % of a linear low density polyethylene, and from 5 to 25 wt % of a performance modifier polymer composition, which has been found to provide an economical roofing membrane which meets the elevated temperature requirements now demanded in the industry. The roofing membrane composition further comprises a flame retardant, an ultraviolet stabilizer, and a pigment. In one embodiment, the linear low density polyethylene comprises a butene comonomer.

In one embodiment, the polypropylene polymer comprises a random polypropylene copolymer.

The foregoing membrane compositions comprising a linear low density polyethylene (LLDPE) are useful in preparing a roofing membrane. The roofing membrane would be prepared from a membrane composition comprising the LLDPE, propylene polymer, and performance modifier in an amount ranging from 40 to 70 wt % of the composition. The remaining membrane composition comprises at least one flame retardant, at least one ultraviolet stabilizer and at least one pigment.

Among other factors, it has been surprisingly discovered that combining linear low density polyethylene with a polypropylene polymer, with a single performance modifier, an economical TPO based roofing membrane with improved UV stability can be obtained. This is particularly achieved using the present polymer blends. Adding the larger amounts of linear low density polyethylene to the formulation has also been discovered to provide some processing advantages. The performance modifier, in particular, provides some stabilization effect to the process and performance modification, particularly reducing rigidity when combined with linear low density polyethylene.

### BRIEF DESCRIPTION OF THE DRAWINGS

FIG. 1 depicts the flexural stress at 5% flexural strain (PSI) for various polymer compositions intended for use in membrane compositions.

FIG. 2 depicts the tensile stress at break (PSI) for various polymer compositions intended for use in membrane compositions.

FIG. 3 depicts the tensile elongation at break (%) for various polymer compositions intended for use in membrane compositions.

FIG. 4 depicts the tear energy at break (lbf-in) for various polymer compositions intended for use in membrane compositions.

### DETAILED DESCRIPTION

As the fastest growing commercial roofing membrane, TPO has become the dominant single ply membrane that provides both good weathering performance and lower cost. For the past decades, a TPO formulation heavily relies on an in-reactor blend resin that has minor polypropylene copolymer as the matrix phase and EP rubber as the majority phase well dispersed in the polypropylene. The rubber phase is so fine and uniformly distributed that it cannot be made by any conventional mechanical mixing. Due to this unique morphology, it gives good mechanical properties yet maintains its flexibility that is preferred by the roofers for installation convenience.

However, recent developmental work in polyolefin formulation found that good mechanical properties including good flexibility can be achieved through a unique blend of polyolefin resins, which blend is also more economical. These blends not only can achieve good mechanical performance but also excellent weathering performance as tested by high temperature heat aging.

The resin present blend comprises linear low density polyethylene (LLDPE). The LLDPE with butene as its comonomer is particularly preferred. In addition, a polypropylene based polymer/copolymer is included. The polypropylene base polymer/copolymer provides mechanical strength and high temperature resistance. In one embodiment, the polypropylene base polymer comprises a random polypropylene copolymer. This polypropylene polymer can replace the in-reactor resin having EP rubber as a majority phase that is now typically used in roofing membranes. However, such in-reactor resins, such as HiFAX™ CA10A can still be used. A mixture of polypropylene resins can also be used.

A performance modifier is also used to ensure a blend that is stable under high temperature and long-term aging. A performance modifier is also used to ensure flexibility and toughness, particularly at low temperatures, while maintaining other good physical and mechanical properties and weathering resistance at service temperature. It does not compromise the high temperature properties, thermal stability and long-term aging of the roofing membrane. In particular, the performance modifier promotes the polymer blend phase stability. The performance modifier may also improve the rheological behavior of the final blend by reducing the shear viscosity and minimizing the shear heating effect during compounding.

The performance modifier could be a polyethylene based copolymer, a polypropylene based copolymer, or a styrene/butadiene (SBS); styrene-ethylene/propylene-styrene (SEPS); and styrene-ethylene/butylene-styrene (SEBS) based copolymer. For polyethylene and polypropylene based performance modifier components, the metallocene made polypropylene and polyethylene copolymer elastomers are preferred. For example, there are two types of random copolymers made by metallocene technology: polypropylene and polyethylene elastomers. The common grades in the market are Engage (available from Dow) or Exact (available from Exxon) or Queo 6800LA from Borealis for the polyethylene matrix copolymer and Versify (Dow) and Vistamaxx (Exxon) for the polypropylene matrix copolymer. Polyethylene and polypropylene based block copolymers, such as Infuse™ and Intune™ from Dow, can be used as well. Moreover, styrene block copolymers from Kraton Corp. of Houston, Tex. can be used in the performance modifier, including SBS, SEPS, SEBS types of block copolymer.

Ethylene-Propylene rubber (EPR) copolymers may also be added to TPO blends in order to achieve the desirable properties typical of roofing membranes, in particular, flexibility and toughness at low temperatures, while maintaining the other good mechanical properties and weathering resistance. EP rubber copolymers such as Exxon Vistalon 501, Vistalon 502, Vistalon 722 and Vistalon 878P may be used for TPO roofing membranes.

The present blend of polymers provides an economical roofing membrane composition that is useful in roofing membranes that exhibit excellent high temperature thermal stability as well as reduced tackiness. These advantages are unprecedented and offer the industry a solution to its quest for a more economical yet a better performing roofing membrane. These advantages have been discovered by combining linear low density polyethylene with the more traditional thermoplastic polyolefin polymers. The linear low density polyethylene substitutes for some of the polyolefin polymers used in conventional roofing membrane polymer blends in a manner still allowing for phase stability. Maintaining phase stability is important, otherwise the physical properties and stability of the finished article are adversely affected. To the contrary, the right balance of linear low density polyethylene has been found to insure phase stability, without changing or modifying the stabilizer package, while also providing a final product of excellent performance. The excellent performance is particularly evident in thermal stability, and maintaining that thermal stability over time.

In general, the present polymers used in preparing the present roofing membrane composition comprises three components. Linear low density polyethylene (LLDPE) is one component.

Liner low density polyethylene (LLDPE) is well known in the polymer industry and is readily available commercially. Linear low-density polyethylene is a substantially linear polymer (polyethylene), with significant numbers of short branches, commonly made by copolymerization of ethylene with longer-chain olefins. Linear low-density polyethylene differs structurally from conventional low-density polyethylene (LDPE) because of the absence of long chain branching. The linearity of LLDPE results from the different manufacturing processes of LLDPE and LDPE. In general, LLDPE is produced at lower temperatures and pressures by copolymerization of ethylene and such higher alpha-olefins as butene, hexene, or octene. The copolymerization process produces an LLDPE polymer that has a narrower molecular weight distribution than conventional LDPE and in combination with the linear structure, significantly different rheological properties.

The production of LLDPE can be initiated by transition metal catalysts, particularly Ziegler or Philips type of catalyst. The actual polymerization process can be done either in solution phase or in gas phase reactors. Usually, octene is the comonomer in solution phase while butene or hexene are copolymerized with ethylene in a gas phase reactor. In one embodiment, butene is used as the commoner producing LLDPE. LLDPE has higher tensile strength and higher impact and puncture resistance than does LDPE. It is very flexible and elongates under stress. It can be used to make thinner films, with better environmental stress cracking resistance. It has good resistance to chemicals. It has good electrical properties.

In one embodiment, provided is a polymer blend composition comprising linear low density polyethylene, a TPO polymer, i.e., a propylene polymer (preferably having no rubber dispersed therein), and a single performance modifier comprising either a polypropylene (PP) matrix or backbone copolymer or a polyethylene (PE) matrix or backbone copolymer.

LLDPE is commercially available from chemical companies such as Exxon Mobil Corporation, The Dow Chemical Company, LyondellBasell Industries N.V., Saudi Basic Industries Corporation (SABIC), Borealis AG, Formosa Plastics Corporation, U.S.A. (Formosa Plastics), China Petroleum & Chemical Corporation (Sinopec Corporation), INEOS Group AG, Chevron Phillips Chemical Company LLC, NOVA Chemicals Corporation, Sasol Limited, and Braskem S.A.

While LLDPE is prepared by copolymerization of ethylene and alpha-olefins, for example, butene, hexene, or octene, for the purposes of the present compositions it is most preferred that butene is the comonomer. It has been discovered that the best performance, processing characteristics and low cost are achieved when the LLDPE is prepared with butene as the comonomer.

Examples of suitable LLDPE resins, with butene comonomer, include Dow™ DFDA-7047 NT7, available from Dow Chemical Company of Midland, Mich.; Chevron Philips 6109CL can also be used successfully. In general, the LLDPE has a density of 0.910 to 0.925 g/cm³, in another embodiment 0.915 to 0.920 g/cm³, and in another embodiment, from 0.916 to 0.918 g/cm³.

The amount of LLDPE used in the present roofing membrane composition ranges from 32 to 57 wt %, and in another embodiment from 35-55 wt %, based on the weight of the roofing membrane. In another embodiment, the amount ranges from 37 to 48 wt %, based on the total weight of the roofing membrane, and in another embodiment from 40 to 55 wt %.

The second component is a thermoplastic polypropylene. Such resin components are well known. The thermoplastic polypropylene component can be a random copolymer, an impact copolymer, or homopolymer. The random polypropylene copolymer generally contains less than 10 mol % ethylene monomer and is preferred because of its softness. The random polypropylene copolymer can comprise, for example, from 1 mol % to less than 10 mol % ethylene monomer.

Such polymers are well known. For example, polypropylene polymers are commercially available from Total Atofina. One such polymer is the random polypropylene polymer Total 7238. Another such polymer is the Borealis SB330CF. Others can be used. Another commercial polypropylene polymer is available from ExxonMobil Chemical Company under the tradename ExxonMobil™ PP. One specific product is ExxonMobil™ pp 7032. Another suitable TPO for roofing membranes is Ineos T00G-00, available from Ineos Olefins and Polymers, U.S.A. An in-reactor blend resin such as HiFAX™ CA10A can also be used and is available from LyondellBasell Industries.

The amount of the thermoplastic polypropylene polymer component in the present membrane composition can generally range from 3 to 6 wt %, and in another embodiment from 4 to 5 wt %, based on the weight of the membrane composition. In another embodiment, the amount of polypropylene polymer can range from 3.5 to 5.5 wt %. The polypropylene polymer component generally has a density that ranges from 0.87 to 0.92 g/cm³, with a density in the range of from 0.88 to 0.91 in one embodiment. The melt flow rate (230° C./2.16 Kg) of the propylene polymer component is generally in the range of from 0.5 to 20 g/10 min, and in one embodiment the melt flow ranges from 0.5 to 5.0 g/10 min. A melt flow rate in the range of from 0.6 to 4.0 g/10 min is exhibited in one embodiment.

The third component is a performance modifier, which generally comprises a single polymer composition. This third component is generally used as a performance modifier in the blend to aid in maintaining the blend and maintaining phase stability. The performance modifier composition can comprise a polyethylene based copolymer, an elastomeric polypropylene based copolymer, a SBS, SEPS, SEBS based copolymer or an ethylene-propylene rubber copolymer. A mixture of the foregoing polymers, copolymers thereof or block copolymers thereof can be used in the performance modifier composition, but it is preferred that the performance modifier polymer composition comprises but a single polymer or copolymer.

Suitable elastomer propylene copolymers that can be used in the performance modifier composition are commercially available, and include Vistamaxx™ copolymers from ExxonMobil Chemical Company. For example, Vistamaxx™ 6102 or 6202 may be used. Exxon Vistalon copolymers can also be used. Versify copolymers available from Dow Chemical can also be successfully used. The polypropylene copolymer generally has a density from 0.860 to 0.900 g/cm³ and a melt flow rate of 1-25 g/10 min.

Suitable ethylene copolymers that can be used in the performance modifier composition are commercially available, and include Engage™, available from Dow Chemical. Engage 8180 is an ethylene-octene copolymer available from Dow Chemical which can be used in one embodiment. Another copolymer is the ethylene alpha olefin copolymer Exact™, such as Exact 5061™, available from ExxonMobil Chemical. In general, the ethylene copolymer has a density in the range of from 0.860 to 0.915 g/cm³, and a melt flow rate in the range of about 0.5 to 5.0 g/10 min.

Polyethylene and polypropylene based block copolymers such as Infuse™ and Intune™ available from Dow Chemical can be used in the performance modifier polymer composition, as well as styrene block copolymers from Kraton Corp. In one embodiment, the styrene block copolymer can be Kraton G-1645MO, which is a styrene-ethylene/butylene-styrene (SEBS) tri-block copolymer. Besides a SEBS styrene block copolymer, styrene/butadiene (SBS) and styrene-ethylene/propylene-styrene (SEPS) block copolymers can also be used, and are available from Kraton Corp.

Ethylene-Propylene rubber (EPR) copolymers such as Vistalon 501, Vistalon 502, Vistalon 722, Vistalon 878P may also be used in the performance modifier polymer composition in order to achieve the desirable properties typical of roofing membranes. In particular, flexibility and toughness at low temperatures, while maintaining the other good mechanical properties and weathering resistance.

The performance modifier is generally present in the roofing membrane composition in an amount ranging from 5 to 25 wt %, based on the weight of the membrane composition, or in one embodiment from 8 to 23 wt %, in another embodiment from about 10 to 20 wt % based on the total weight of the membrane composition. In one embodiment, the amount ranges from 12 to 18 wt %. The relative ratio of the copolymer performance modifiers used depends on the desired viscosity or flow properties of the blend. In general, a single polymer can be used, such as a polyethylene based copolymer. In one embodiment, the polyethylene based copolymer is an ethylene octene copolymer.

The polymers in the membrane composition can be first prepared as a blend before additives such as a flame retardant, UV stabilizer, and/or pigment is mixed into the composition. The blend of polymers can be prepared by physically blending the different components. The blend is therefore a combination of polymer components that have already been formed and recovered before mixing or otherwise combined. The blending can also occur somewhat in solutions, miscible carriers, or by melt blending. The resulting blend is a multiphase polymer composition having sufficient amounts of the polymers that the final roofing membrane composition comprises from 32 to 57 wt % of a linear low density polyethylene, from 3 to 6 wt % of a polypropylene polymer or copolymer, and from 5 to 25 wt % of a performance modifier.

The balance of components in the blend is important because polypropylene and polyethylene will not maintain phase stability if the mix is not balanced. Instead, regions of polypropylene and polyethylene will form, which will affect the physical properties and stability of the finished article adversely. However, by maintaining the components in the present range of the membrane composition, it has been found that a polymer blend including LLDPE is obtained which maintains phase stability and provides good mechanical properties and even improved heat stability. Cost efficiency is also realized by the present blend, while still achieving improved performance characteristics.

In order to achieve a roofing membrane composition exhibiting the present polymer amounts should a blend of polymers first be prepared by physical blending, the amount of each polymer component in the three component blend can vary, but be adjusted as needed. In one embodiment, the amount of LLDPE in the three component blend can generally range from 59 to 82 wt % of the polymer blend, the amount of polypropylene component in the polymer blend can range from 6 to 8.5 wt %; and, the amount of performance modifier can range from 10 to 35 wt % based on the weight of the three component polymer blend.

Once the polymer blend has been achieved, and often pelletized, the blend can be used to prepare a membrane for use in a roof. Generally, a membrane composition is prepared where certain additives and fillers are added to the polymer blend. In one embodiment, at least one flame retardant, at least one ultraviolet stabilizer and at least one pigment is added to the polymer blend. This prepares a membrane composition comprising from 40-70 wt % of the polymer blend, based on the weight of the entire membrane composition, with the remaining components comprising at least one flame retardant, an ultraviolet stabilizer and pigment. In one embodiment, a membrane composition comprising from 55 to 68 wt % polymer blend, based on the weight of the entire membrane composition, can be prepared. In another embodiment, the polymer blend can comprise from 60 to 67 wt % of the membrane composition. In another embodiment, the blend of polymer components can comprise about 63.5 wt % of the roofing membrane composition.

The flame retardant can be present, in one embodiment, in an amount ranging from 20 to 45 wt %. The pigment can be present in an amount of 3 to 6 wt %, and in one embodiment, in an amount of about 5 wt %. The pigment often used is TiO₂. In one embodiment, UV stabilizer can be present in the membrane composition in an amount ranging from about 1 to 7 wt %, and in one embodiment in an amount ranging from 2 to 7 wt %, and in another embodiment in an amount of about 2 wt % of the membrane composition. Based on the weight of the entire membrane composition, in one embodiment the amount of polypropylene polymer can range from 3 to 6 wt %, or from 3.5 to 5.5 wt % in another embodiment. The amount of LLDPE ranges from 35 to 55 wt % in one embodiment, from 40 to 55 wt % in another embodiment, and from 43 to 52 wt % in another embodiment. The performance modifier ranges from 5 to 25 wt % in one embodiment, and from 6 to 23 wt % in another embodiment. Adjustments within the ranges can be made.

As noted above, the compositions described herein can also incorporate a variety of additives. The additives may include reinforcing and non-reinforcing fillers, antioxidants, stabilizers, processing oils, compatibilizing agents, lubricants (e.g., oleamide), antiblocking agents, antistatic agents, waxes, coupling agents for the fillers and/or pigment, pigments, flame retardants, and other processing aids known to the art. In some embodiments, the additives may comprise up to about 60 wt %, or up to about 55 wt %, or up to about 50 wt % of the roofing membrane composition. In some embodiments, the additives may comprise at least 25 wt %, or at least 30 wt %, or at least 35 wt %, or at least 40 wt % of the roofing membrane composition.

In some embodiments, the roofing membrane composition may include fillers and coloring agents. Exemplary materials include inorganic fillers such as calcium carbonate, clays, silica, talc, titanium dioxide or carbon black. Any type of carbon black can be used, such as channel blacks, furnace blacks, thermal blacks, acetylene black, lamp black and the like.

In some embodiments, the roofing composition may include flame retardants, such as calcium carbonate, inorganic clays containing water of hydration such as aluminum trihydroxides (“ATH”) or magnesium hydroxide. For example, the calcium carbonate or magnesium hydroxide may be pre-blended into a masterbatch with a thermoplastic resin, such as polypropylene, or a polypropylene/polyethylene copolymer. For example, the flame retardant may be pre-blended with a polypropylene, where the masterbatch comprises at least 40 wt %, or at least 45 wt %, or at least 50 wt %, or at least 55 wt %, or at least 60 wt %, or at least 65 wt %, or at least 70 wt %, or at least 75 wt %, of flame retardant, based on the weight of the masterbatch. The flame retardant masterbatch may then form at least 5 wt %, or at least 10 wt %, or at least 15 wt %, or at least 20 wt %, or at least 25 wt %, of the roofing composition. In some embodiments, the roofing composition comprises from 5 wt % to 40 wt %, or from 10 wt % to 35 wt %, or from 15 wt % to 30 wt % flame retardant masterbatch, where desirable ranges may include ranges from any lower limit to any upper limit. The calcium carbonate can also be added directly as a powder into the physical mixing process, such as a twin extrusion process.

The presence of calcium carbonate together with the large amount of LLDPE has been found to be of particular advantage when the amount of calcium carbonate in the membrane composition is at least 25 wt %. In one embodiment, the amount of calcium carbonate is at least 27 wt % of the membrane composition.

In some embodiments, the roofing membrane composition may include UV stabilizers, such as titanium dioxide or Tinuvin® XT-850. The UV stabilizers may be introduced into the roofing membrane composition as part of a masterbatch. For example, UV stabilizer may be pre-blended into a masterbatch with a thermoplastic resin, such as polypropylene. For example, the UV stabilizer may be pre-blended with a polypropylene or an impact polypropylene-ethylene copolymer, where the masterbatch comprises at least 2 wt %, 5 wt %, or at least 7 wt %, or at least 10 wt %, or at least 12 wt %, or at least 15 wt %, of UV stabilizer, based on the weight of the masterbatch. Alternatively, the UV stabilizer may be pre-blended with a LLDPE resin. The UV stabilizer masterbatch may then form at least 2 wt %, or at least 5 wt %, or at least 7 wt %, or at least 10 wt %, or at least 15 wt %, of the roofing membrane composition. In some embodiments, the roofing composition comprises from 2 wt % to 30 wt %, or from 7 wt % to 25 wt %, or from 10 wt % to 20 wt % UV stabilizer masterbatch, where desirable ranges may include ranges from any lower limit to any upper limit.

Still other additives may include antioxidants and/or thermal stabilizers. In an exemplary embodiment, processing and/or field thermal stabilizers may include IRGANOX® B-225 and/or IRGANOX® 1010 available from BASF.

The compositions described herein are particularly useful for roofing applications, such as for thermoplastic polyolefin roofing membranes. Membranes produced from the compositions may exhibit a beneficial combination of properties, and in particular exhibit an improved balance of flexibility at temperatures across a wide range, along with enhanced heat aging/UV stability properties. The roofing compositions described herein may be made either by pre-compounding or by in-situ compounding using polymer-manufacturing processes such as Banbury mixing or twin screw extrusion. This physical blending can then be followed by a calendaring process. In one embodiment, the components are directly fed into an extruder such that melting, mixing, and extrusion occurs simultaneously, and then calendaring the extruded material, which can then be wound into a roll if desired. In one embodiment, the polymers are blended to prepare a polymer blend, and then the additives are added to the polymer blend with physical blending. In one embodiment, the process includes laminating cap and core layers into a full membrane, with a reinforcing scrim optionally placed between the cap and core layers. The compositions are thus formed into roofing membranes. The roofing membranes may be particularly useful in commercial roofing applications, such as on flat, low-sloped, or steep-sloped substrates.

The roofing membranes may be fixed over the base roofing by any means known in the art such as via adhesive material, ballasted material, spot bonding, or mechanical spot fastening. For example, the membranes may be installed using mechanical fasteners and plates placed along the edge sheet and fastened through the membrane and into the roof decking. Adjoining sheets of the flexible membranes are overlapped, covering the fasteners and plates, and preferably joined together, for example with a hot air weld. The membrane may also be fully adhered or self-adhered to an insulation or deck material using an adhesive. Insulation is typically secured to the deck with mechanical fasteners and the flexible membrane is adhered to the insulation.

In one embodiment, the roofing membrane can comprise more than one layer. For example, the membrane can comprise a cap or top layer, and a core or lower layer, with an optional reinforcing scrim between cap and core. While the polymer composition of each of the layers is essentially the same, the additives may vary. The cap layer is directed to UV protection and therefore may contain a greater UV stabilizer concentration than the core layer. The core layer can be designed for more heat protection, and therefore contain more antioxidants than the cap layer. Each layer provides a separate focused function based on the additives present, but with the polymer composition being within that of the present blend so that the benefits of the present blend as described above can be realized.

The following Examples are provided to further illustrate certain embodiments but the Examples are not intended to be limiting.

Four distinct LLDPE/rPP/Performance modifier systems, as described in Case 1, Case 2, Case 3 and Case 4 were compared to a “Control” formulation.

Case 1: When considered with respect to the polymer blend composition, in the specific case of using 68.2 wt % linear low-density polyethylene (LLDPE), 6.8 wt % rPP (Total rPP 7238) and 25.0 wt % performance modifier (Exxon Exact 5061), testing of the tensile properties in the machine direction indicated a tensile stress at break of 3153±93 PSI and a tensile elongation at break of 792±14%. Testing of the flexural properties in the machine direction indicated a flexural modulus of 752±59 PSI (flexural stress at 5% flexural strain). Testing of the tear properties (Die-C-tear) in the machine direction indicated a tear energy at break of 28.9±0.5 lbf-in.

Testing of the tensile properties in the cross-machine direction indicated a tensile stress at break of 3026±43 PSI and a tensile elongation at break of 794±8%. Testing of the flexural properties in the cross-machine direction indicated a flexural modulus of 624±38 PSI (flexural stress at 5% flexural strain). Testing of the tear properties (Die-C-tear) in the cross-machine direction indicated a tear energy at break of 33.5±1.6 lbf-in.

Case 2: When considered with respect to the polymer blend composition, in the specific case of using 68.2 wt % linear low-density polyethylene (LLDPE), 6.8 wt % rPP (Total rPP 7238) and 25.0 wt % performance modifier (Kraton G1645 MO), testing of the tensile properties in the machine direction indicated a tensile stress at break of 2723±206 PSI and a tensile elongation at break of 701±38%. Testing of the flexural properties in the machine direction indicated a flexural modulus of 865±52 PSI (flexural stress at 5% flexural strain). Testing of the tear properties (Die-C-tear) in the machine direction indicated a tear energy at break of 28.7±3.3 lbf-in.

Testing of the tensile properties in the cross-machine direction indicated a tensile stress at break of 2168±100 PSI and a tensile elongation at break of 771±19%. Testing of the flexural properties in the cross-machine direction indicated a flexural modulus of 742±89 PSI (flexural stress at 5% flexural strain). Testing of the tear properties (Die-C-tear) in the cross-machine direction indicated a tear energy at break of 35.3±1.5 lbf-in.

Case 3: When considered with respect to the polymer blend composition, in the specific case of using 59.0 wt % linear low-density polyethylene (LLDPE), 5.9 wt % rPP (Total rPP 7238) and 35.1 wt % performance modifier (Exxon Vistamaxx 6102), testing of the tensile properties in the machine direction indicated a tensile stress at break of 2490±119 PSI and a tensile elongation at break of 756±20%. Testing of the flexural properties in the machine direction indicated a flexural modulus of 899±21 PSI (flexural stress at 5% flexural strain). Testing of the tear properties (Die-C-tear) in the machine direction indicated a tear energy at break of 28.6±4.4 lbf-in.

Testing of the tensile properties in the cross-machine direction indicated a tensile stress at break of 2284±180 PSI and a tensile elongation at break of 839±19%. Testing of the flexural properties in the cross-machine direction indicated a flexural modulus of 776±73 PSI (flexural stress at 5% flexural strain). Testing of the tear properties (Die-C-tear) in the cross-machine direction indicated a tear energy at break of 35.0±2.8 lbf-in.

Case 4: When considered with respect to the polymer blend composition, in the specific case of using 81.7 wt % linear low-density polyethylene (LLDPE), 8.2 wt % rPP (Total rPP 7238) and 10.1 wt % performance modifier (Exxon Vistalon 501), testing of the tensile properties in the machine direction indicated a tensile stress at break of 2524±167 PSI and a tensile elongation at break of 819±1%. Testing of the flexural properties in the machine direction indicated a flexural modulus of 747±109 PSI (flexural stress at 5% flexural strain). Testing of the tear properties (Die-C-tear) in the machine direction indicated a tear energy at break of 18.7±0.9 lbf-in.

Testing of the tensile properties in the cross-machine direction indicated a tensile stress at break of 2131±123 PSI and a tensile elongation at break of 801±1%. Testing of the flexural properties in the cross-machine direction indicated a flexural modulus of 517±30 PSI (flexural stress at 5% flexural strain). Testing of the tear properties (Die-C-tear) in the cross-machine direction indicated a tear energy at break of 23.0±2.5 lbf-in.

When considered with respect to the total formulation, the polymer blend composition described in Case 1, Case 2, Case 3 and Case 4 comprises 63.5 wt % (sum of polyethylene, polypropylene and performance modifier). Moreover, the polypropylene to polyethylene ratio was chosen as ˜0.10 in order to improve critical properties and performance, in particular, weathering, flexural softness and fitness for use.

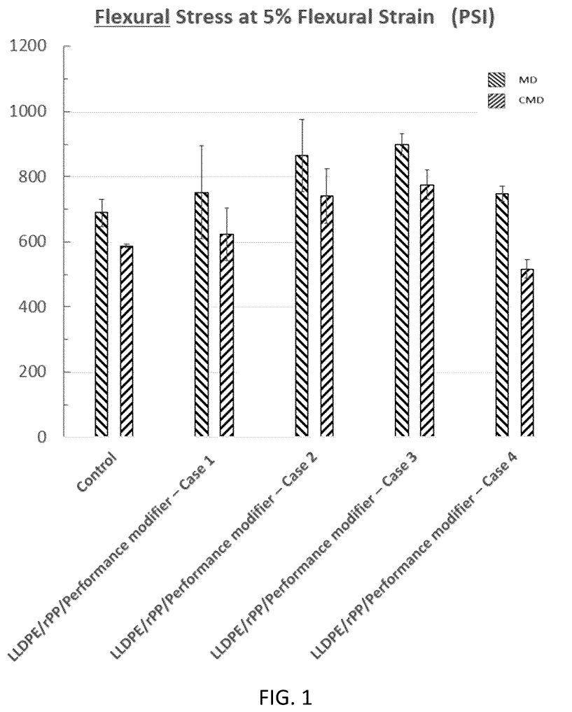

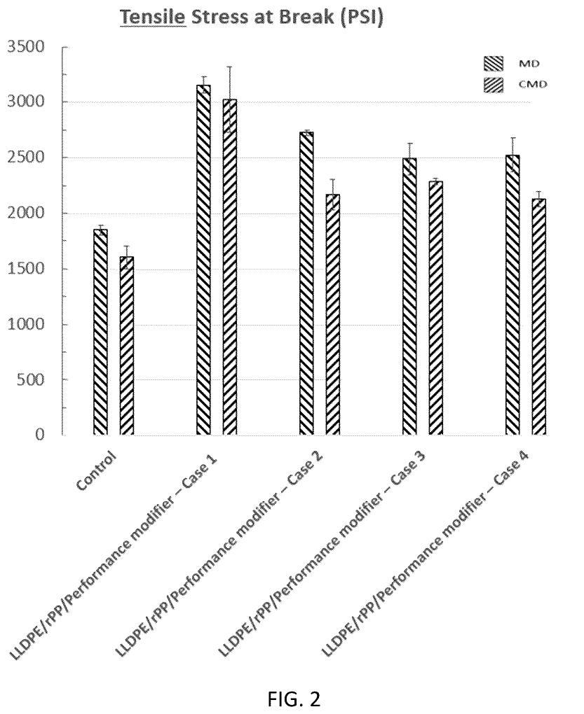

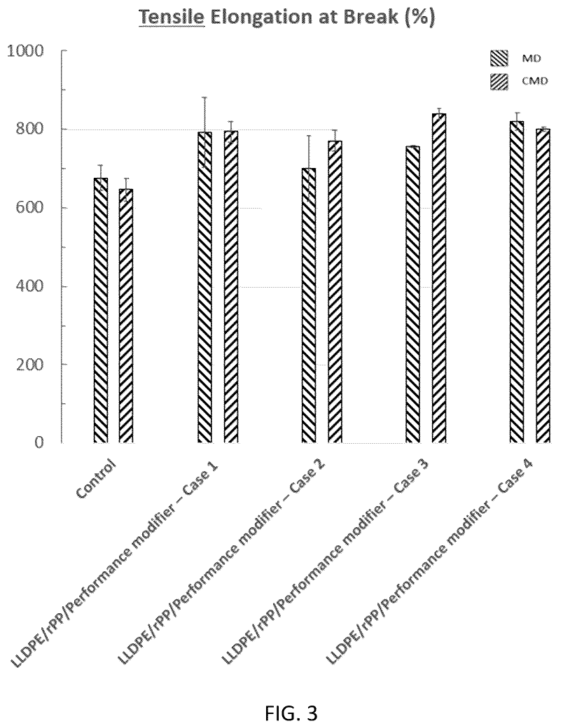

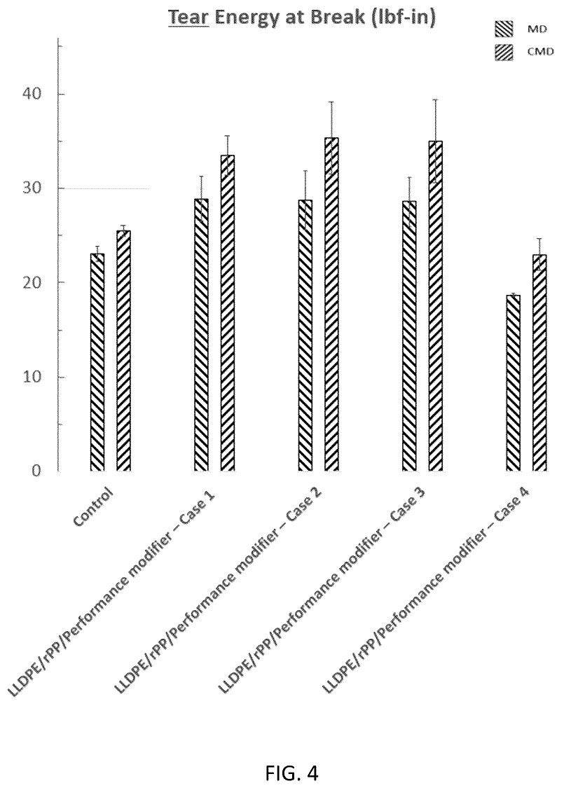

The results of the testing when using 63.5 wt % of the polymer blend of cases 1, 2, 3, and 4 are provided below in Table form. The results for flexural stress at 5% flexural strain are graphically depicted in FIG. 1 for each of the four cases and the control. The results for tensile stress at break are graphically depicted in FIG. 2 for the control and the four cases in FIG. 2. The results for tensile elongation at break for the control and the four cases are graphically depicted in FIG. 3. The tear energy at break results for the control and the four cases are depicted graphically in FIG. 4.

| | | LLDPE/rPP/ | LLDPE/rPP/ |
|---|---|---|---|
| | | Performance | Performance |
| | | modifier - | modifier - |
| Property | Control | Case 1 | Case 2 |
| Tensile Stress at Break, | 1849 ± 65 | 3153 ± 93 | 2723 ± 206 |
| MD (PSI) | | | |
| Tensile Elongation at Break, | 675 ± 15 | 792 ± 14 | 701 ± 38 |
| MD (%) | | | |
| Flexural Stress at 5% Flexural | 689 ± 16 | 752 ± 59 | 865 ± 52 |
| Strain, MD (PSI) | | | |
| Tear Energy at Break, C-tear, | 23.1 ± 2.4 | 28.9 ± 0.5 | 28.7 ± 3.3 |
| MD (lbf-in) | | | |
| Tensile Stress at Break, | 1604 ± 20 | 3026 ± 43 | 2168 ± 100 |
| CMD (PSI) | | | |
| Tensile Elongation at Break, | 646 ± 7 | 794 ± 8 | 771 ± 19 |
| CMD (%) | | | |
| Flexural Stress at 5% Flexural | 587 ± 22 | 624 ± 38 | 742 ± 89 |
| Strain, CMD (PSI) | | | |
| Tear Energy at Break, Die | 25.5 ± 2.1 | 33.5 ± 1.6 | 35.3 ± 1.5 |
| C-tear, CMD (lbf-in) | | | |

| | | LLDPE/rPP/ | LLDPE/rPP/ |
|---|---|---|---|
| | | Performance | Performance |
| | | modifier - | modifier - |
| Property | Control | Case 3 | Case 4 |
| Tensile Stress at Break, | 1849 ± 65 | 2490 ± 119 | 2524 ± 167 |
| MD (PSI) | | | |
| Tensile Elongation at Break, | 675 ± 15 | 756 ± 20 | 819 ± 1 |
| MD (%) | | | |
| Flexural Stress at 5% Flexural | 689 ± 16 | 899 ± 21 | 747 ± 109 |
| Strain, MD (PSI) | | | |
| Tear Energy at Break, C-tear, | 23.1 ± 2.4 | 28.6 ± 4.4 | 18.7 ± 0.9 |
| MD (lbf-in) | | | |
| Tensile Stress at Break, | 1604 ± 20 | 2284 ± 180 | 2131 ± 123 |
| CMD (PSI) | | | |
| Tensile Elongation at Break, | 646 ± 7 | 839 ± 19 | 801 ± 1 |
| CMD (%) | | | |
| Flexural Stress at 5% Flexural | 587 ± 22 | 776 ± 73 | 517 ± 30 |
| Strain, CMD (PSI) | | | |
| Tear Energy at Break, Die | 25.5 ± 2.1 | 35.0 ± 2.8 | 23.0 ± 2.5 |
| C-tear, CMD (lbf-in) | | | |

MD indicates “Machine Direction”, while CMD indicates “Cross-Machine Direction” or “Transverse Direction”.
Control formulation is based on 63.5% LyondellBasell CA10A, 27% CaCO₃, 5% heat and UV stabilizers, 4.5% TiO₂ concentrate.
The “LLDPE/rPP/Performance modifier-Case 1” formulation is based on 43.3% LLDPE (LyondellBasell Petrothene GA501020), 4.3% rPP (Total rPP 7238), 15.9% Exxon Exact 5061, 27% CaCO₃, 5% heat and UV stabilizers, 4.5% TiO₂ concentrate.
The “LLDPE/rPP/Performance modifier-Case 2” formulation is based on 43.3% LLDPE (LyondellBasell Petrothene GA501020), 4.3% rPP (Total rPP 7238), 15.9% Kraton G1645 MO, 27% CaCO₃, 5% heat and UV stabilizers, 4.5% TiO₂ concentrate.
The “LLDPE/rPP/Performance modifier-Case 3” formulation is based on 37.45% LLDPE (LyondellBasell Petrothene GA501020), 3.75% rPP (Total rPP 7238), 22.3% Exxon Vistamaxx 6102, 27% CaCO₃, 5% heat and UV stabilizers, 4.5% TiO₂ concentrate.
The “LLDPE/rPP/Performance modifier-Case 4” formulation is based on 51.9% LLDPE (LyondellBasell Petrothene GA501020), 5.2% rPP (Total rPP 7238), 6.4% Exxon Vistalon 501, 27% CaCO₃, 5% heat and UV stabilizers, 4.5% TiO₂ concentrate.

When compared to prior polymer blend compositions described in U.S. Pat. No. 10,647,839B2 and U.S. Pat. No. 11,286,380B2, the composition described herein provides significant improvements on critical performance, in particular, better initial mechanical properties (tensile, tear and flexural).

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A roofing membrane composition comprising:
a) from 32 to 57 wt % of a linear low density polyethylene (LLDPE);
b) from 3 to 6 wt % of a thermoplastic polypropylene polymer or copolymer; and
c) from 5 to 25 wt % of a performance modifier;
d) at least one flame retardant;
e) at least one ultraviolet stabilizer; and
f) at least one pigment.

2. The roofing membrane composition of claim 1, wherein the combined wt % of the polymers a), b), and c) ranges from 40 to 70 wt % of the roofing membrane composition.

3. The roofing membrane composition of claim 1, wherein the combined wt % of the polymers a), b), and c) ranges from 55 to 68 wt % of the roofing membrane composition.

4. The roofing membrane composition of claim 3, wherein the combined wt % of the polymers a), b), and c) ranges from 60 to 67 wt % of the roofing membrane composition.

5. The roofing membrane composition of claim 3, wherein the combined wt % of the polymers a), b), and c) ranges about 63.5 wt % of the roofing membrane composition.

6. The roofing membrane composition of claim 1, wherein the flame retardant comprises 10 to 40 wt % of the composition.

7. The roofing membrane composition of claim 6, wherein the flame retardant comprises 25 to 40 wt % of the composition.

8. The roofing membrane composition of claim 1, wherein the pigment comprises from 3 to 6 wt % of the composition.

9. The roofing membrane composition of claim 8, wherein the pigment comprises TiO₂.

10. The roofing membrane composition of claim 1, wherein the UV stabilizer comprises about 2 to 7 wt % of the composition.

11. The roofing membrane composition of claim 10, wherein the UV stabilizer comprises about 2 wt % of the composition.

12. The roofing membrane composition of claim 1, comprising calcium carbonate.

13. The roofing membrane composition of claim 1, wherein the flame retardant comprises calcium carbonate.

14. The roofing membrane composition of claim 12 or 13, wherein calcium carbonate comprises at least 25 wt % of the membrane composition.

15. The roofing membrane composition of claim 12 or 13, wherein calcium carbonate comprises at least 27 wt % of the membrane composition.

16. The roofing membrane composition of claim 14, wherein the amount of calcium carbonate comprises at least about 30 wt % of the membrane composition.

17. The roofing membrane composition of claim 1, wherein the LLDPE is present in the membrane composition in an amount ranging from 35 to 55 wt % of the membrane composition.

18. The roofing membrane composition of claim 1, wherein the LLDPE is present in the membrane composition in an amount ranging from 40 to 55 wt % of the membrane composition.

19. The roofing membrane composition of claim 1, wherein the LLDPE is present in the membrane composition in an amount ranging from 37 to 48 wt % of the membrane composition.

20. The roofing membrane composition of claim 1, wherein the LLDPE is present in the membrane composition in an amount ranging from 43 to 52 wt % of the membrane composition.

21. The roofing membrane composition of claim 1, wherein the polypropylene polymer is present in the membrane composition in an amount ranging from 4 to 5 wt % of the membrane composition.

22. The roofing membrane composition of claim 1, wherein the polypropylene polymer is present in the membrane composition in an amount ranging from 3.5 to 5.5 wt % of the membrane composition.

23. The roofing membrane composition of claim 1, wherein the performance modifier is present in the polymer blend in an amount ranging from 6 to 23 wt % based on the weight of the membrane composition.

24. The roofing membrane composition of claim 1, wherein the performance modifier is present in the polymer blend in an amount ranging from 8 to 22 wt % based on the weight of the membrane composition.

25. The roofing membrane composition of claim 1, wherein the performance modifier is present in the polymer blend in an amount ranging from 10 to 20 wt % based on the weight of the membrane composition.

26. The roofing membrane composition of claim 1, wherein the performance modifier is present in the polymer blend in an amount ranging from 12 to 18 wt % based on the weight of the membrane composition.

27. A roofing membrane comprising the roofing membrane composition of claim 1.

28. A roof comprising the roof membrane of claim 27.

29. The roof of claim 28, wherein the roofing membrane is fixed over base roofing by adhesive material, ballasted material, spot bonding, or mechanical spot fastening.

30. The roof of claim 29, wherein the roofing membranes have been installed by mechanical fasteners and plates placed along an edge sheet and fastened through the membrane and into roof decking.

31. The roof of claim 30, wherein adjoining sheets of roofing membrane are overlapped so as to cover the fasteners and plates and joined together by a hot air weld.

32. A method of preparing a roofing membrane, which comprises physically blending the components of claim 1.

33. The method of claim 32, wherein the roofing membrane is produced by a combination of twin screw extrusion as the physical blending followed by a calendaring process.

34. The method of claim 33, wherein the components are directly fed into an extruder such that melting, mixing, and extrusion occurs simultaneously, and then calendaring extruded material.

35. The method of claim 34, wherein the calendared extruded material is wound into a roll.

36. The method of claim 32, further comprising laminating cap and core layers into a full membrane with a reinforcing scrim optionally placed between the cap and core layers.
